(19) United States
(12) Patent Application Publication
(10) Pub. No.: US 2013/0264971 A1
(43) Pub. Date: Oct. 10, 2013

(54) Method of supporting DALI protocol between DALI controllers and devices over an intermediate communication protocol

(71) Applicant: VERIFIED ENERGY, LLC, Rochester, NY (US)

(72) Inventors: Thomas I. Yeh, Rochester, NY (US); David W. Sheehan, Glenville, NY (US)

(73) Assignee: VERIFIED ENERGY, LLC, Rochester, NY (US)

(21) Appl. No.: 13/802,048

(22) Filed: Mar. 13, 2013

Related U.S. Application Data
(60) Provisional application No. 61/610,342, filed on Mar. 13, 2012.

(51) Int. Cl. H05B 37/02

(52) U.S. Cl. CPC H05B 37/0254
USPC 315/312

(57) ABSTRACT

Methods of supporting DALI protocol between DALI controllers and devices over an intermediate communication protocol are disclosed. We will describe an implementation of the invention using the mesh wireless network prescribed by IEEE 802.15.4 as an intermediate protocol where it's long latency and highly variable delay characteristics poses a significant challenge to maintain adherence with the DALI specification. For practitioners skilled in the art it is obvious that the invention is also applicable to many other communication mediums and protocols, including wired networking such as Ethernet and Wifi networking such as IEEE 802.11 a/b/g/n. Additionally, the invention is applicable to transport other control protocols where specification limits the duration between forward messages and associated reverse replies.

### CROSS-REFERENCE TO RELATED PATENT APPLICATIONS

Priority for this patent application is based upon provisional patent application 61/610,342 (filed on Mar. 13, 2012). The disclosure of this United States patent application is hereby incorporated by reference into this specification.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provide for by the terms of DOE Cooperative Agreement DE-EE0003971 CFDA No. 81.086 awarded by the Department of Energy.

### TECHNICAL FIELD

The current invention relates to lighting control systems for homes, offices, commercial spaces, parking, exterior perimeter and public areas; more particularly to incorporating wireless networks into the lighting control systems; more particularly to lighting control systems using digitally addressable lighting interface (DALI) command protocol.

### BACKGROUND OF THE INVENTION

Centrally controlled lighting systems for homes, offices, commercial spaces, and public areas are well known in the art. One such control system is known as digital addressable lighting interface (DALI). DALI is a digital protocol for lighting control devices. DALI's two-wire physical network is a data bus connecting up to 64 DALI lighting control devices, such as ballasts, occupancy sensors, photo sensors and switch panels, to one DALI controller via physical and electrical connections termed as “ports”. Ports are physical and electrical connections for the DALI Controller and control devices to inter-connect. The DALI controller may be a central computer or other intelligent control unit.

Standards for DALI protocol such as National Electronics Manufacturers Association LSD 53-2010 in the United States and DALI Manual by ZVEI-Division Luminaires of Frankfurt Germany are well known in the Art.

In a wired implementation, a single DALI two-wire physical network is referred to as a “stream.” A stream may contain just a single DALI control device or as many as 64 DALI control devices, in addition to the stream's DALI Controller. Each DALI stream is limited to one DALI Controller serving as the Bus Master initiating all DALI commands. Each of the DALI control devices is assigned a unique address.

In FIG. 1 a simplified typical wired implementation of a DALI control system 100 is depicted. As those skilled in the art are aware, a DALI stream is defined as at least one DALI controller 110 and at least one controlled device 210 interconnected by a bus 120 made of two wires. To improve the noise immunity of the bus 120 the two wires are frequently deployed as a twisted pair.

DALI controllers and controlled devices may be connected as a star or (more commonly) may be daisy chained. The DALI specification provides for up to 64 controlled devices (ballasts, switches, sensors, etc.) to be connected to a common twisted pair bus. The bus 120 also requires a DC voltage, which may be physically provided as a standalone power supply 130 or the power supply function may be integrated into the physical package of a DALI controller or controlled device. Only one power supply is allowed.

Consequently, a DALI stream is one or more DALI controllers connected to a common twisted pair bus with up to 64 DALI controlled devices. The stream is energized by a DC voltage provided by a standalone power supply or by a DALI device connected to the stream.

One DALI controller 110 with a DALI port is connected to one DALI stream consisting of at least a single DALI controlled device 210 via a wired data bus 120. A DALI controlled device 210 is typically a DALI controllable ballast in a DALI controllable network but as those skilled in the art are aware, the DALI specification (NEMA LSD 53-2010) includes additional controlled device types, such as switch device, slide dimmer, motion (occupancy) sensor, scheduler, gateways, to name a few. The DALI specification also allows for multiple DALI controllers initiating DALI commands (both commands requiring no response and commands (also known as query commands or queries) requiring a response from the controlled devices) to the controlled devices connected on the same stream as the controllers. The terms “query” and “query command” as used herein are interchangeable and refer to a command that receives data from a controlled device either through a response containing data received from the controlled device or through the absence of a response in the case of certain queries.

In a wired implementation, a single stream and a DALI port has a one to one correspondence. One DALI port is also physically a single DALI stream formed by the two communications wires emanating and connecting all the DALI controlled devices on the stream. A ballast may be wired to a lamp 220 or a bank of lamps.

DALI protocol by specification is designed to transmit data at 1,200 cycles per second (Hertz (Hz)), plus or minus 10 percent. The time duration of each cycle is nominally equal to 833.33 microseconds.

A DALI forward frame is defined as a command transmitted from the DALI controller and contains an address byte and one or two data bytes.

A 2-bytes DALI forward frame, consisting of one address byte and a data byte, has 19-bits of data. A 3-bytes DALI forward frame, consisting of one address byte and two data bytes, has 27-bits of data.

A DALI back frame, defined as a reply responding to the immediate forward frame, consists of 11-bits of data.

DALI protocol employs Manchester encoding for serial data transmission. Manchester encoding requires two sampling intervals to decode a single data bit. DALI protocol refers to each sampling interval as “TE”. The duration of each TE is one half of 833.33 microseconds.

Standards for DALI protocol such as NEMA LSD 53-2010 in the United States and DALI Manual by ZVEI-Division Luminaires of Frankfurt Germany have identified reserved elements of the protocol for future expansion and for manufacturer specific extensions. A reserved element or a manufacturing specific extension element of the DALI protocol may be used as a special command within the current DALI specification. The original DALI specification based on 2-byte commands only supports reserved commands, which in theory should not be used for manufacturer extensions, although it is rather common for manufacturers to use reserved commands for their specific extensions. In the more current DALI specification such as the NEMA document the element of manufacturer specific commands are explicitly identified separately from the reserved commands.

In a DALI control system, the DALI controller 110 is frequently sending commands and queries to the DALI controlled devices 210 to ensure optimal operation of the DALI controlled devices 210. The DALI specification maintains a 22 TE maximum limit for each DALI controlled device 210 to respond to the DALI controller 110 for DALI commands requiring a response. This maximum limit of 9.16667 milliseconds is encoded into the protocol and is required of each DALI controlled device 210 when responding to the DALI controller 110.

There are many reasons why implementation using a wireless network would be desired, including simplifying building renovation and reduced installation expense by elimination of problematic communication wiring (i.e. long run communication wiring). A significant shortcoming of wireless network based implementations (e.g. implementing ZigBee protocol) is that the communications between devices cannot be guaranteed to occur within the DALI specification's maximum response time. The timing requirements of the DALI protocol are designed for a communication media where a DALI controller and the connected DALI stream is hardwired in a fashion that the delays or latency introduced by the media are near zero. This makes DALI incompatible with wireless communication media, where latency is non-deterministic and varies greatly depending on real-time network conditions, and can exceed the timing requirements of the DALI protocol. This is problematic for DALI configuration and special commands where the commands must be repeated within a specified timeframe as received by the DALI controlled device on the connected stream or it will be ignored. For DALI query commands, the protocol specifies a very short timing requirement for the responding DALI back frame (e.g. “data”) such that it is unreliable for most wireless networking schemes, especially a wireless network with low to moderate data rate such as ZigBee Alliance's IEEE 802 based high level communication protocols standard for personal area networks (PANs), to maintain compatibility with the DALI protocol. A DALI controlled device must begin transmitting a response to a DALI controller within 22TE (about 9.17 ms). Any processing overhead to encode/decode a wireless signal (which is non-zero) the wireless transmission itself makes adherence to this difficult. With a protocol like ZigBee, it is typical to take at least 10-15 ms per communication hop through the network, which breaks this 22TE response transmission initiation requirement immediately. As those skilled in the art are aware, in Zigbee a communication transmission may be relayed through multiple devices; each transmission between devices is referred to as a hop. Each communication transmission is termed a cluster; each ZigBee cluster, defined by a 16-bit identifier, contains both a command and at least one attribute where each command causes an action and each attribute tracks the current state of an element of the cluster (e.g., a level control cluster command can tell a ballast to adjust the intensity of a light and an attribute tracks the intensity of the light).

There are many instances where it is advantages to transport the DALI protocol by an intermediate communication protocol such as wireless network, before converting back to the wired DALI data bus to complete a lighting control application. However, simple encapsulation of the DALI protocol inside another communication protocol may not guarantee adherence to the DALI specification. For example, DALI specification requires the transition time between message frames is limited to a maximum of 22 bit-periods (‘22 Te’) or 9.966 milliseconds (ms) for the 1200 Hz+/−4% DALI data rate.

Many intermediate communication protocols, especially wireless protocols, would not be capable of guaranteeing the time period between a forward frame message originated by a DALI controller, transported by the intermediate communication protocol and delivered to the intended DALI control device, and to deliver response from the intended DALI control device back to the DALI controller within the maximum allowable transition time required by the DALI specification. This problem is made more difficult by the DALI control device consuming almost the entire 9.966 ms allowable transition time after receiving the DALI Controller's forward frame before responding with its reverse frame, leaving no allowance for the intermediate communication protocol to introduce additional delays.

Without implementing a caching approach it will be costly, complicated and difficult to guarantee compliance with the DALI specification's maximum 22 TE limit for the DALI controlled device to response to the DALI controller. DALI commands that do not require a response from the DALI controlled device (e.g. unidirectional commands) do not require any accommodations on a controller-side wireless module functioning as an encapsulation gateway. In order to transparently encapsulate the DALI protocol, the encapsulation gateway attached to the DALI controller (controller-side encapsulation gateway) must cache data for all commands that the DALI controller could dispatch.

Simple encapsulation of the underlying DALI protocol over an intermediate communication link, such as Zigbee or Ethernet, is inadequate to guarantee adherence to the DALI specification therefore requiring the DALI controller to be aware of and to compensate for the characteristics of the intermediate communication medium.

This invention allows any intermediate communication link to be used in lighting control networks while guaranteeing adherence to the underlying lighting control protocol specification and also allowing the intermediate link to be used transparently to other devices in the system.

The present invention described herewith allows for a wireless intermediate link due to the low-bandwidth, high-latency characteristics of wireless which poses significant challenges to proper DALI system operation. However, the methods of the present invention pertain to any intermediate link, including wired mediums such as Ethernet.

The present invention is an improvement over the current art. This invention allows any intermediate communication protocol to be used in a DALI control network while guaranteeing adherence to the underlying DALI specification and also allowing the intermediate protocol to be deployed transparently to the DALI devices on the network. This invention does not require special accommodation by the DALI controller and DALI control devices.

In designing a straight forward caching approach to command and back frame transmittals, the present invention uses novel methods to overcome several issues including the following.

1. To control a large lighting network consisting of hundreds of ballasts controlled by a single controller a controller-side gateway will require a substantial data store which will require a significant amount of memory. Common wireless gateways use low cost microcontrollers where memory conservation would lower hardware cost and offers cost advantages.

2. In a caching scheme, data is continually collected from the controlled devices and stored in a data cache by a device-side wireless gateway. Cache data updates are subsequently sent to a controller-side gateway, these updates need to be transmitted in a manner that does not overwhelm the available bandwidth of the intermediate link.

3. The data in the data store representing the states of control devices (e.g. the current state of an occupancy sensor or the light level sensed by a photometric sensor) can quickly become outdated in constantly changing conditions. This stale data can delay and adversely affect proper functioning of the lighting control system on the upstream DALI controller so a method to use a wireless intermediate link must include a robust method to maintain and update the current state of control devices.

4. The caching scheme will require a simple configuration. DALI controlled device and control-system manufacturers often rely on proprietary reserved DALI commands to supplement the abilities of standardized DALI commands provided in the DALI specification. It is necessary for the caching scheme to be capable of detecting manufacturer's reserved DALI commands and to continuously adapt the data store without external intervention.

Due to the diverse nature of DALI Controllers and control devices, having an interoperable approach is critical. The present invention allows for a baseline set of capabilities with DALI controllers that do not support the additional special DALI commands and a set of advanced capabilities for DALI controllers that do. The present invention relates to the encapsulation of DALI commands in wireless networks and uses several novel methods to reduce transmission latency of communications within a DALI network configured to use a wireless communication method while still maintaining DALI communication timing requirements. Though the examples of the present invention in this document are directed to DALI controllers, it should be obvious to those skilled in the art that the methods described may be used with any lighting system controlling device.

### SUMMARY OF THE INVENTION

FIG. 2 depicts a simplified DALI control application with a wireless network serving as an intermediary communication protocol between a DALI controller 310 and a DALI controlled device 370. For clarity the figure portrays wireless gateways (controller-side wireless module 330 and device-side wireless module 350) functionally separated and attached to the DALI controller 310 and the DALI controlled device 370. The purpose of the wireless gateways is to transport DALI data and commands for over the wireless network. The invention applies equally when the wireless modules are integrated within either or both the DALI controller 310 and the DALI controlled device 370.

Cable replacement mode (CRM) is a technique that allows an intermediate communication medium to be placed between the DALI controller 310 and DALI controlled devices 370 transparently thereby allowing full adherence to the DALI specification.

Simple encapsulation of the underlying DALI protocol over an intermediate communication link is inadequate to guarantee adherence to the DALI specification therefore the DALI controller 310 is required to be aware of and to compensate for the characteristics of the intermediate communication medium.

The present invention allows any intermediate communication link to be used in lighting control networks while guaranteeing adherence to the underlying lighting control protocol specification and also allowing the intermediate link to be used transparently to other devices in the system.

The present invention specifies how DALI commands and their associated responses are cached on the controller-side wireless module 330 and device-side wireless module 350. To keep the response time to DALI commands issued by the DALI controller 310 within the 22 bit-periods of the DALI data rate stipulated by the DALI specification, the cached values are used to reply to commands directly by the controller-side wireless module 330 without waiting for the current response back from the DALI controlled device 370. Keeping the cached value current to insure the DALI controller has the correct values for its operation is a key feature of the present invention. Moreover, the cached value may be derived by the wireless modules or it may be the actual data polled from the DALI controlled device.

In one preferred embodiment of the present invention, a method to allow the mesh wireless network prescribed by IEEE 802.15.4 as an intermediate protocol in a DALI system where the mesh network's long latency and highly variable delay characteristics pose a significant challenge to maintain adherence with the DALI specification. It will be obvious for practitioners skilled in the art that the present invention is also allows for additional intermediary communication mediums and protocols, including wired networking such as Ethernet and Wifi networking such as IEEE 802.11a/b/g/n within a DALI system. Additionally, the invention is applicable systems using other control protocols which specify limits to the duration between forward messages and associated reverse replies. Another novel feature of the present invention is the ability to reduce data latency by implementing dynamic prioritization of DALI commands.

The controller-side wireless module monitors the frequency of DALI commands issued by the connected DALI controller. Commands are stored in a command list; for each command in the command list cache, a priority is continuously computed that equates to the proportion of DALI stream bandwidth that is dedicated to servicing that command. This computed or allocated DALI stream utilization metric for each command is delivered to all the device-side wireless modules on the wireless network whenever it changes by a pre-determined threshold (e.g. +/−1%).

The device-side wireless modules takes all of the available DALI bandwidth not being used for unidirectional (non-cached) commands and proportionally divides it up based on this computed or allocated utilization percentage.

In order to keep higher-priority commands up to date, commands are interwoven. In the first cycle, each command in the cache is issued one after another. In the subsequent cycles, the highest priority commands will be issued again and the lower priority commands will be omitted.

For example, commands A, B, C, and D of decreasing priority may be issued as follows:
Cycle 1: A, B, C, D
Cycle 2: A
Cycle 3: A, B
Cycle 4: A
Cycle 5: A, B

Table 1 presents representative command utilization data and the corresponding DALI bandwidth usage for the example from above.

TABLE 1

| Command | Times Issued | Total Commands Run | Utilization % |
|---|---|---|---|
| A | 5 | 10 | 50% |
| B | 3 | 10 | 30% |
| C | 1 | 10 | 10% |
| D | 1 | 10 | 10% |

However, as seen, the commands get interwoven such that command A is issued the most frequently, evenly distributed throughout a single pass of 10 commands.

FIG. 3 illustrates a scenario where commands can be prioritized. The pie-chart in FIG. 3 shows an example of how various commands uses the available DALI bandwidth. The regions at the top of the pie chart, “Set Arc Level” and “Other”, are non-cached, non-query and other selectively excluded query commands and have fixed priorities. However, the other commands clearly show that the DALI controller spends more time querying the occupancy sensor than querying the light level in this example.

FIG. 4 shows a common lighting control scenario where 85% of the DALI bandwidth from the FIG. 3 example are command queries and therefore are cache eligible. The 15% that are not cached are dispatched by the device-side wireless module each time they are received from the DALI controller and are prioritized over the commands issued directly by the device-side wireless module to update the data cache. The percentages listed in FIG. 4 are not intended to represent all lighting control scenarios. It is used as an illustrative example used to explain the dynamic prioritization of the present invention.

FIG. 5 presents an example of command implementation in a standard DALI implementation on the controlled device side of a DALI network for the DALI command distribution presented in FIG. 3. Without using dynamic prioritization, it is shown in FIG. 5 shows that each command takes up an equal percentage of the available DALI bandwidth (85%).

FIG. 6 presents an example of command implementation on the controlled device side of a DALI network using dynamic prioritization for the DALI command distribution presented in FIG. 3. As is readily apparent when comparing the results presented in FIGS. 3 & 6, the effective DALI stream utilization on the device-side exactly matches that on the controller-side and will keep the data in the cache current.

The invention also provides for Preemptive Cache Management to reduce data latency in the cache. To reduce data latency the data cache on the controller-side wireless module is designed with a data structure that is specific to and for each DALI controlled device in the lighting system. This data structure maintains the values for each cached data command that cannot be derived from other values. As an example, the data cache maintains the light level of the ballast but not whether the lamp is lit. The latter parameter is a function of the former and therefore can be determined if the DALI controller queries to see if the lamp is lit.

The controller-side wireless module cache is preemptively updated when the controller-side wireless module detects a forward frame changing the state of a particular DALI device. This preemptive approach dramatically reduces or eliminates the cache age for some DALI state properties of the DALI devices.

FIG. 7 illustrates the intended ‘normal’ behavior of a representative DALI system for an example DALI command. Time is presented vertically and elapses going downward in the diagram. The values in the table circled have changed as a result of the corresponding event.

FIG. 8 illustrates the behavior of a representative DALI system in the event of an error. Time is presented vertically and elapses going downward in the diagram. The values in the table circled have changed as a result of the corresponding event.

For existing DALI systems each device-side module attempts to fully utilize the available bandwidth on their DALI streams to issue commands that are part of the data cache. In the baseline case, a cache update message would be sent to the DALI controller for each of these underlying queries. This is highly wasteful given that the values do not typically change between every query and this utilizes a significant amount of bandwidth on the intermediate link and imposes significant processing requirements on the controller-side node to handle each message. The present invention only transmits data value changes from controlled devices through to the device-side wireless modules saving bandwidth and improving the data age for the system.

For many intermediate protocols, the packet header for each message sent consists of more data than the actual payload of the message. In cases with significant network congestion on the intermediate data link, data grouping can be utilized to improve the header/payload ratio and more effectively use the bandwidth.

This technique adds some additional latency between the time the data was collected from the ballast and when it actually gets sent to the controller. As a result, it is intended to be dynamically enabled/disabled based on real-time assessment of the intermediate link bandwidth by the gateway modules.

This technique can be used with or without the “Only Transmit Data Value Changes” technique.

The present invention can also be deployed beyond lighting control to other building systems, such as Heating, Air Conditioning and Ventilation systems.

### BRIEF DESCRIPTION OF FIGURES

Embodiments of the present invention will be described by reference to the following drawings, in which like numerals refer to like elements, and in which:

FIG. 1 depicts a hard wired lighting system using a DALI interface;

FIG. 2 depicts an exemplary wireless lighting system using a DALI interface;

FIG. 3 depicts a chart of a representative example of DALI command distribution on a controller-side wireless module;

FIG. 4 depicts a chart of DALI command cacheability;

FIG. 5 depicts a chart of a representative example of DALI command distribution on a device-side wireless module;

FIG. 6 depicts another chart of a representative example of DALI command distribution on a device-side wireless module;

FIG. 7 depicts an example response to a DALI command;

FIG. 8 depicts an example erroneous response to a DALI command;

FIG. 9 depicts in additional detail an exemplary wireless lighting system using a DALI interface;

FIG. 10 depicts a flow chart for a method to process a wireless command on a device-side wireless module;

FIG. 11 depicts a flow chart for a method to process a wireless command on a controller-side wireless module;

FIG. 12 depicts a flow chart for a method to prioritize a wireless command;

FIG. 13 depicts a flow chart for a method to prioritize a wireless back frame;

FIG. 14 depicts a flow chart for a method for a preemptive cache update control logic; and

FIG. 15 depicts a flow chart for a method for ballast grouping control logic on forward frame arrival.

FIG. 16 depicts a representative example of a ballast grouping memory table and a representative example of a ballast grouping exception table structure.

FIG. 17 depicts a representative example of the sequencing of cache updates upon a data value change.

FIG. 18 depicts a representative example of the sequencing of grouped cache updates.

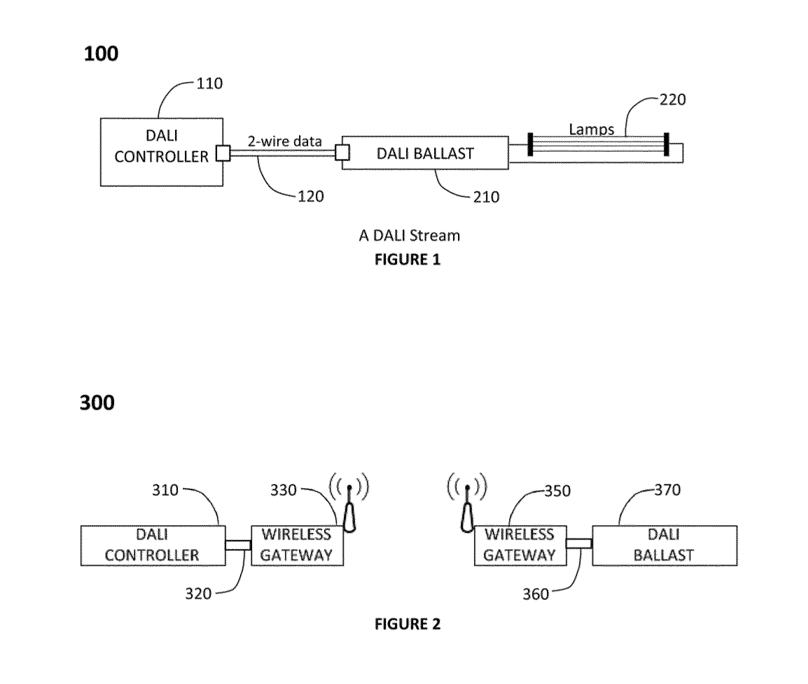

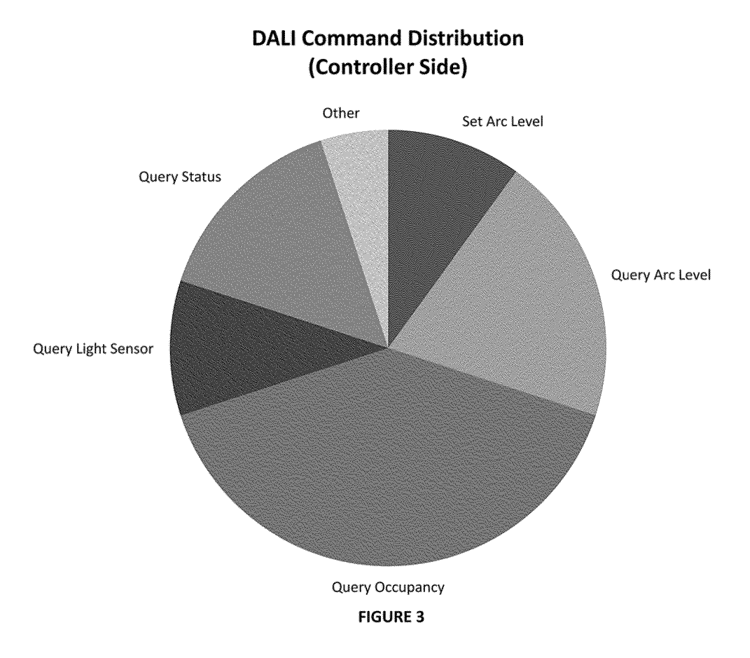

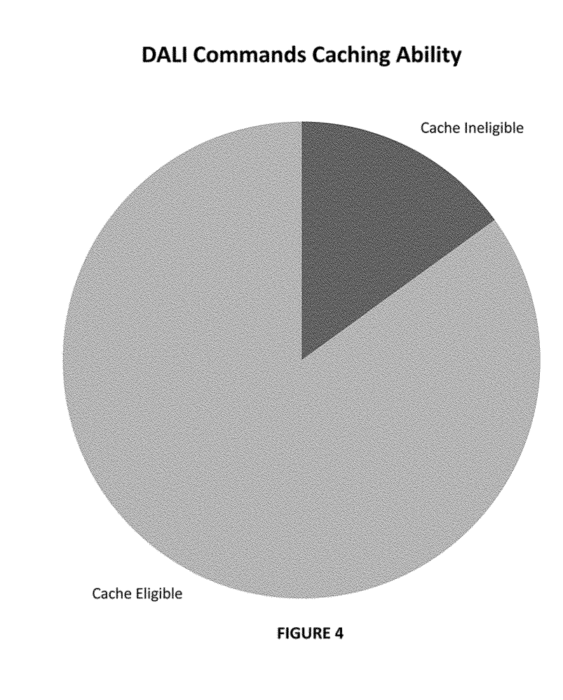

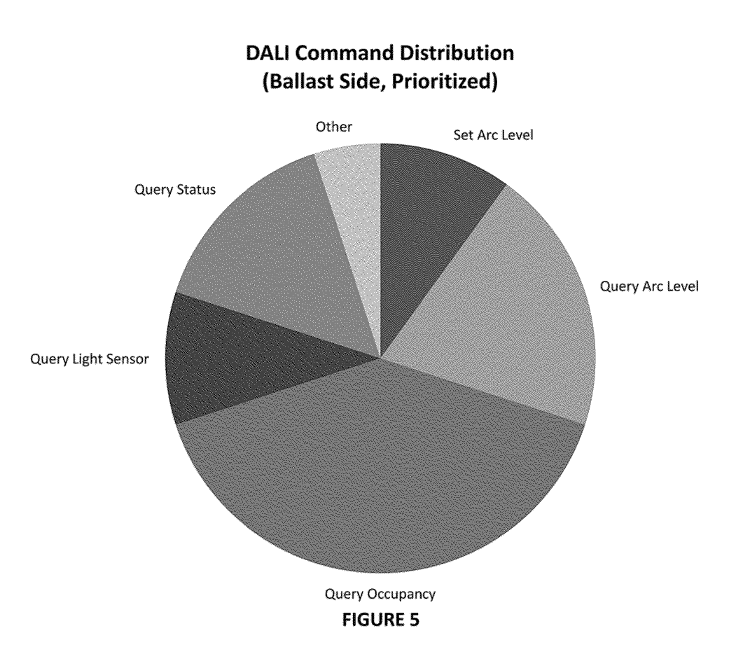

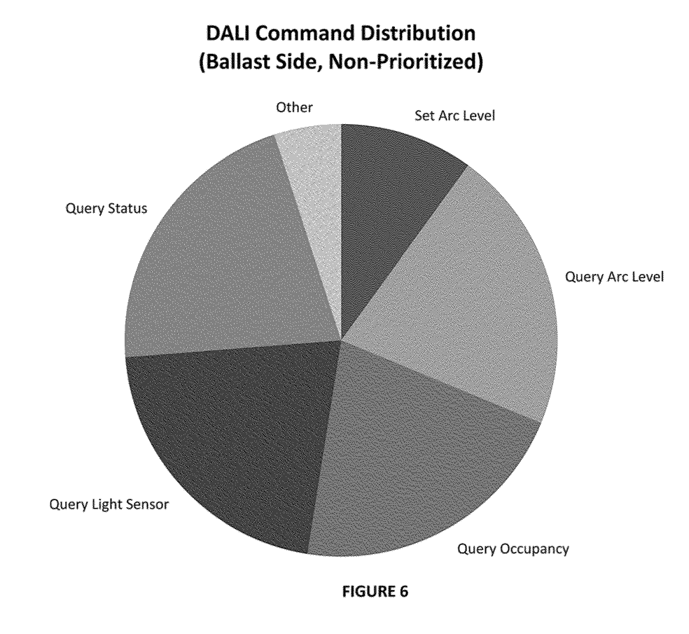

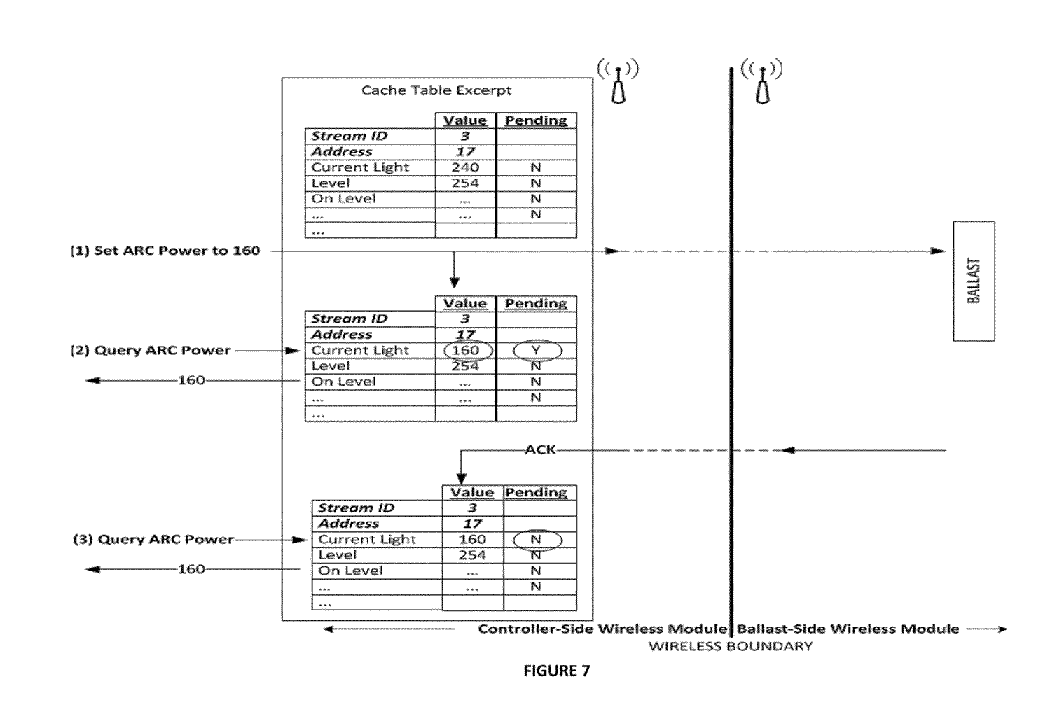

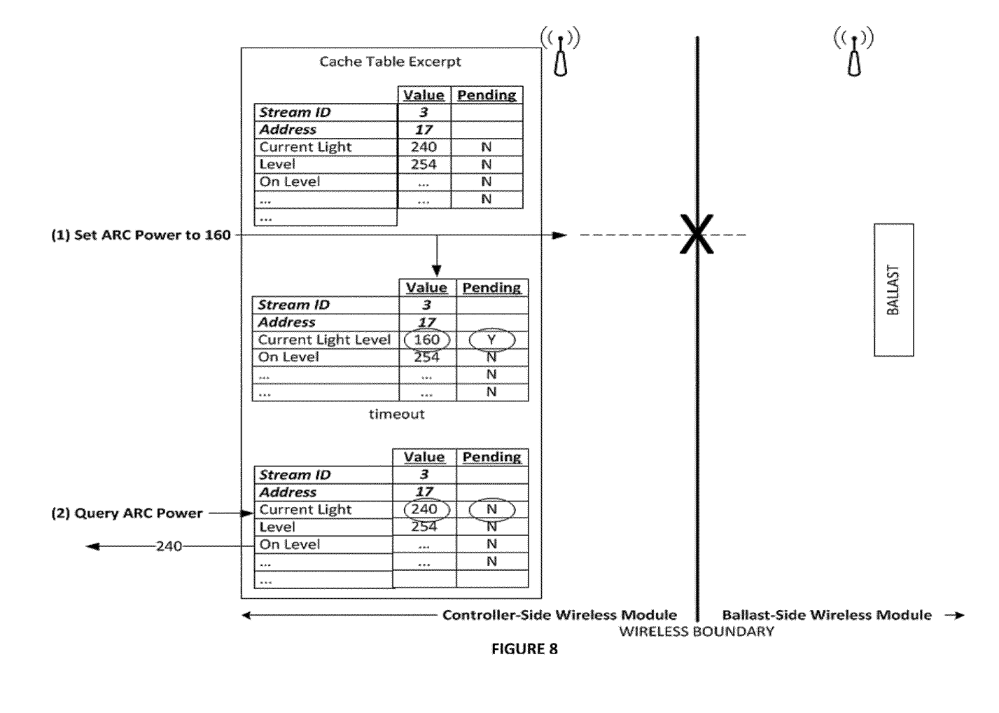

### DETAILED DESCRIPTION OF THE INVENTION

We will describe an implementation of the invention using the mesh wireless network prescribed by IEEE 802.15.4 as an intermediate protocol where it's long latency and highly variable delay characteristics poses a significant challenge to maintain adherence with the DALI specification. For practitioners skilled in the art it is obvious that the invention is also applicable to many other communication mediums and protocols, including wired networking such as Ethernet and Wifi networking such as IEEE 802.11a/b/g/n. Additionally, the invention is applicable to transport other control protocols where specification limits the duration between forward messages and associated reverse replies.

Referring again to FIG. 2 a preferred embodiment of an exemplary lighting control system 200 is depicted. A DALI controller 310 is connected via a first two wire data bus 320 (e.g. a twisted pair wire) to a controller-side wireless module 330. The controller-side wireless module 330 communicates via a wireless communication protocol to up to 64 device-side wireless modules 350. In this specification, the term wireless gateway may refer to at least one controller-side wireless module 330 or at least one device-side wireless module 350. For ease of narrative the wireless communication protocol in this representative example will be the ZigBee communication protocol. Other wireless communication protocols may be utilized. Each device-side wireless module 350 is connected via a second two wire data bus 360 to at least one DALI stream comprising at least one DALI ballast 370 (slave) which is connected to at least one lamp bank 380 (not depicted). To simplify the description, the term “ballast” will refer to any “peripheral device” that may be used in a DALI stream and the two terms may be used interchangeably along with the term “controlled device”. As those skilled in the art are well aware these peripheral devices may include, but are not limited to, ballasts, sensors, dimmer switches, timers, and the like. A DC power supply, not shown, may be integrated with the DALI Controller 310 or may be provided separately to the DALI controller 310. A separate DC power supply, also not shown, may be integrated with each device-side wireless module 350 or may be provided separately to each. Yeh and Sheehan disclose a method to encapsulate DALI commands in wireless networks in a patent cooperation treaty application (PCT/US/12/48340) which is hereby incorporated by reference in its entirety. The controller-side wireless module 330 and the device-side wireless module 350 each comprise a set of software components that encode and decode the DALI protocol and handle data encapsulation over an intermediate wireless medium while maintaining a reference to the DALI stream the traffic originated from and is destined to arrive and which provide for the seamless control of each lamp bank 380 by the DALI controller 310 even though the DALI controller 310 is not hard wired directly to DALI ballasts 370. It should be obvious to those skilled in the art that in other embodiments of the present invention that the DALI controller 310 may be wired directly to additional ballasts provided the DALI controller 310 does not perceive more than 64 ballasts on a single stream and also that the presence of DALI streams hardwired to a DALI controller does not preclude the novelty of the present invention.

The DALI controller 310 issues a command in the form of a DALI forward frame to one or more DALI controlled devices 370 and expects to receive a valid DALI back frame reply within 22 TE (bit periods) limit. The forward frame DALI command is transmitted to the controller-side wireless module 330 which encapsulates the DALI command and transports it over a wireless protocol to the device-side wireless module 350. The device-side wireless module 350 extracts the DALI command and dispatches the command on the DALI bus to at least one connected DALI controlled device 370.

In one preferred implementation of the invention, the command list cache is constructed and maintained by the device-side wireless module 350. Whenever commands are added to or removed from the cache on the device-side wireless module 350, a notification message is sent to the controller-side wireless module 330 data store 337 to keep the command list 357 and the data store 337 in synchronization. This allows the device-side wireless module 350 to properly process a forward frame requesting data by the connected DALI controller 310, i.e., sending a response immediately with data from the cache.

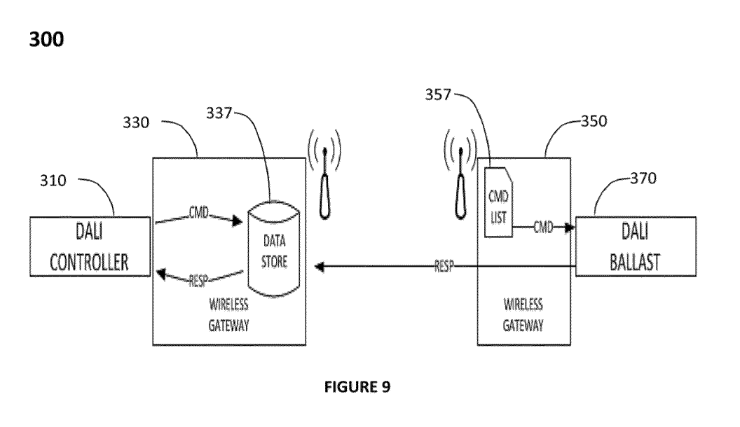

FIG. 9 presents a more detailed representation of the preferred embodiment of the present invention. The data store 337 resides on the controller-side wireless module.

Another data store, not depicted, is on each device-side wireless module for storing the command list 357. The controller-side wireless module knows this as it centralizes configuration of the list, in cases of dynamic prioritization it needs to know this list to determine the priorities, and at the most basic level the command list is the left column of a data table that comprises the data store.

Both the controller-side and device-side wireless modules maintain command lists. On the controller-side wireless module the commands in the command list are automatically responded to by the controller-side wireless module to satisfy the 22TE response time requirement and are also used to configure all the device-side wireless modules. On each of the device-side wireless modules, the commands in the command list are the commands that are issued on the local DALI stream for data that will be cached.

The data store 337 on the controller-side wireless module 330 is used to respond to the DALI controller 310 within 22TE for all the queries on the network regarding all the ballasts 370 controlled by the DALI Controller 310. On the device-side wireless module 350, a data store, not depicted, contains commands for only the DALI controlled devices connected to that particular module. This subset of the data store is used to determine if the appropriate value changed and needs to be sent to the controller-side wireless module 330.

The command list 357 is on the device-side wireless module 350. The command list 357 is initially populated with a default list of commands. This list of commands (cache) is prepopulated with queries that are required for basic system operation. This allows the cache to be populated before the DALI controller 310 begins issuing commands and allows the device-side wireless module 350 to only have to issue queries required for device-side wireless module 350 operation without consideration for other required queries potentially not being available until later. DALI commands are issued by the DALI controller 310 and cached to the command list 357 automatically by the device-side wireless module 350.

When the device-side wireless module 350 sees a command that is followed by a back frame that is not in its list 357 of cached commands, the command will be added to the command list 357 automatically (such as a reserved, non-standard command).

Discovered query commands will continue to be cached in the command list 357 as long as the DALI ballast 370 keeps responding to the queries.

When the controlled device 370 stops responding to queries, the cache values will not update on the controller-side wireless module data store 337.

Whenever a wireless message is received by the controller-side wireless module 330 from a device-side wireless module 350, it is used to update the data store 337 cache, or add a new command to the data store 337 command cache if it was found to be a query instead of a unidirectional command.

When values on the controller-side wireless module 330 become too old, the controller-side wireless module 330 will no longer place back frames on the controller-side stream (responding to the DALI controller's 310 query); that is the same behavior as if the DALI peripheral 370 was wired directly to the DALI controller 310.

If the DALI controller 310 issues a query for a command that is not contained in the data store 337 cache, the controller-side wireless module 330 will not respond to the query. As a result, there is a startup time at which the controller-side wireless module 330 will not respond to commands while the data store 337 cache is being populated. It is expected that it will only take several seconds to initially construct the cache. It should be obvious to those skilled in the art that the data store 337 cache could initially be populated with default values to speed the system startup; and using a prepopulated cache will not avoid the present invention.

All commands issued by the DALI controller 310 that are not part of the data store 337 cache are forwarded to the device-side wireless module 350 and executed normally in sequence. This is mostly applicable to commands that do not require a response from the controlled device 370.

When the DALI bus is not busy (i.e. idle) the device-side wireless module 350 will automatically dispatch the commands from the command list 357 and return the response to the controller-side wireless module 330. The controller-side wireless module 330 will cache the response to the commands in the command list 337 and will reply with the cached value the next time the DALI controller 310 issues that same command. This allows the controller-side wireless module 330 to respond with a DALI back frame within the maximum 22 TE of the DALI specification.

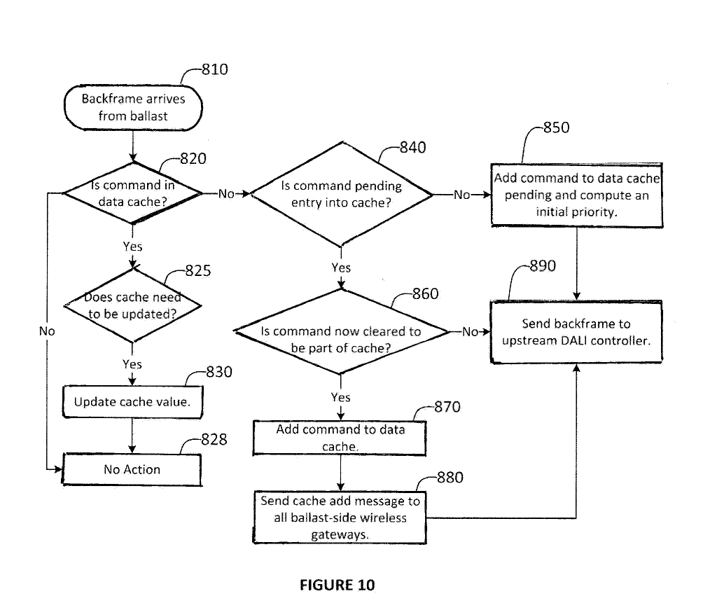

FIG. 10 presents a flow chart of the method used to process DALI and wireless commands on a controller-side wireless module and device-side wireless module. FIG. 10 depicts the control logic for transmitting responses (back frames) from controlled devices using device-side wireless module command lists.

Each controlled device in a DALI network may have a different list of commands that it responds to than other controlled devices within the network and therefore each may have a different set of commands cached in its command list. This provides great flexibility for the system but also requires the controller-side wireless module to have enough random access memory (RAM) to manage the responses from each of the command lists.

In step 810 the device-side wireless module receives a back frame from a controlled device. In step 820, the device-side wireless module determines whether the command associated with that back frame is currently in the command list. If the command is in the command list, the device-side wireless module determines whether the command has been previously detected (i.e. has the command been issued by the DALI controller) in step 825. If the command has not been previously detected no further action is required (step 828). If the command has been previously detected, then in step 830 a timestamp for that command is updated in the command list cache; reflecting that the intended DALI controlled device is still actively responding to the command.

If in step 820, it was determined that the command associated with the back frame is not in the command list cache, then the back frame is checked against a pending command list in step 840. The pending command list contains a listing of commands that have been received but have a lower priority than commands in the command list. These low priority commands are not initially placed into the command list until their priority surpasses that of commands currently in the command list. If the command is not in the pending command list, the command is added to the pending command list in step 850 and the back frame is transmitted back to the DALI controller in step 890.

In step 880, a time stamp is placed on the command, a counter recording how often the command is received is initialized, and an initial priority is assigned to the command. The time stamp allows the wireless gateway to track how frequently the DALI controller issues that command. If the command is in the pending command list, in step 860 the counter is incremented and a determination is made as to whether that command should be moved from the pending command list to the command list cache. If the command list cache isn't full, the command may be added to the command list once it has been repeatedly issued over a several minute period. If the command list cache is full, then the pending command's priority is compared to that of the lowest priority command already in the command list cache. One method to determine the relative priority of the two commands may be to compare how frequently each command is issued. If the pending command is issued more frequently than the lowest priority command for a predetermined threshold time, then the lowest priority command is removed to the pending command list and the pending command is placed in the command list cache in step 870. In step 870 a notification message is transmitted to the controller-side wireless module to allow the controller-side wireless module to properly handle a forward frame requesting data from the associated queries.

In step 880 the command list cache is transmitted to all device-side wireless modules. In step 890 the back frame is transmitted back to the DALI controller.

Referring again to step 860, if the pending command does not have high enough priority to replace any command currently in the command list cache the back frame is transmitted to the DALI controller without the associated command being added to the command list cache.

Periodically the data in the command list cache and in the pending command list are inspected to determine if any entries should be removed due to the commands not being issued for longer than a predetermined threshold. In the preferred embodiment this occurs every few minutes during idle time on the module and only auto-detected commands which have not been issued more than a preconfigured number of times to continuously connected and responsive controlled devices are removed.

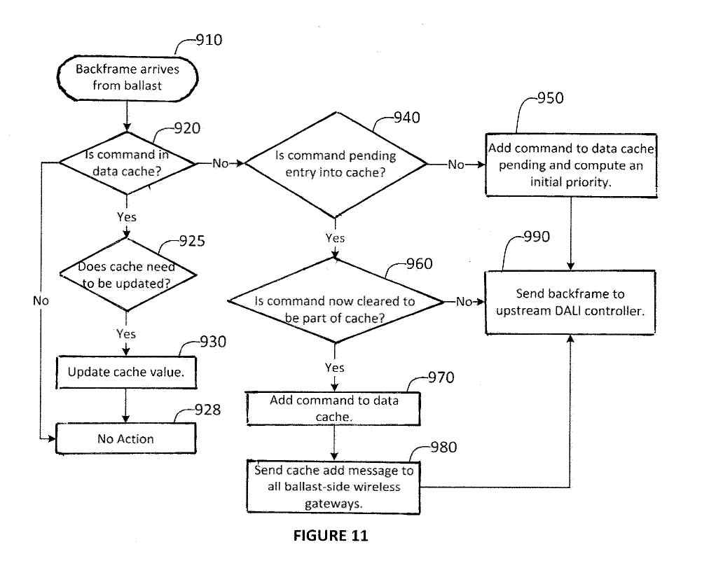

In another preferred implementation of the invention, a command list cache is constructed and maintained by the controller-side wireless module 330. This approach allows for significant memory optimizations on the controller-side wireless module 330 within a lighting system possessing a large number of controlled devices partitioned into multiple streams, each with a separate device-side wireless module connecting to a DALI stream. The controller-side wireless module 330 has visibility to commands issued to all the connected device-side wireless modules, whereas each device-side wireless module only has visibility to commands issued to the DALI devices on its own DALI stream. Additional memory optimization and utilization is available because there is only once instance of each command in the command list cache maintained by the controller-side wireless module 330, whereas each device-side wireless module maintaining its own command list cache would store the particular command in its own command list cache. Moreover since many controlled devices behave identically, there is greater consistency in the characteristics of data stored in the single controller-side wireless module 330 command list cache and the DALI controller will receive on average the same data age and same command response latency for every command issued. FIG. 11. depicts a flowchart of the logic used in this embodiment of the present invention.

In step 910 a controller-side wireless module receives a back frame from a controlled device via a device-side wireless module. In step 920, the controller-side wireless module determines whether the command associated with that back frame is currently in the command list. If the command is in the command list, the controller-side wireless module determines whether the command has been previously detected (i.e. has the command been issued by the DALI controller) in step 925. If the command has not been previously detected no further action is required (step 928). If the command has been previously detected, then in step 930 a timestamp for that command is updated in the command list cache; reflecting that the intended DALI controlled device is still actively responding to the command.

If in step 920, it was determined that the command associated with the back frame is not in the command list cache, then the back frame is checked against a pending command list in step 940. The pending command list contains a listing of commands that have been received but have a lower priority than commands in the command list. These low priority commands are not initially placed into the command list until their priority surpasses that of commands currently in the command list. If the command is not in the pending command list, the command is added to the pending command list in step 950 and the back frameback frame is transmitted back to the DALI controller in step 990.

In step 980, a time stamp is placed on the command, a counter recording how often the command is received is initialized, and an initial priority is assigned to the command. The time stamp allows the wireless gateway to track how frequently the DALI controller issues that command. If the command is in the pending command list, in step 960 the counter is incremented and a determination is made as to whether that command should be moved from the pending command list to the command list cache. If the command list cache isn't full, the command may be added to the command list once it has been repeatedly issued over a several minute period. If the command list cache is full, then the pending command's priority is compared to that of the lowest priority command already in the command list cache. One method to determine the relative priority of the two commands may be to compare how frequently each command is issued. If the pending command is issued more frequently than the lowest priority command for a predetermined threshold time, then the lowest priority command is removed to the pending command list and the pending command is placed in the command list cache in step 970. In step 970 a notification message is transmitted to the controller-side wireless module to allow the controller-side wireless module to properly handle a forward frame requesting data from the associated queries.

In step 980 the command list cache is transmitted to all device-side wireless modules. In step 990 the back frame is transmitted back to the DALI controller.

Referring again to step 960, if the pending command does not have high enough priority to replace any command currently in the command list cache the back frame is transmitted to the DALI controller without the associated command being added to the command list cache.

Periodically the data in the command list cache and in the pending command list are inspected to determine if any entries should be removed due to the commands not being issued for longer than a predetermined threshold. In the preferred embodiment this occurs every few minutes during idle time on the module and only auto-detected commands which have not been issued more than a preconfigured number of times to continuously connected and responsive controlled devices are removed.

### Dynamic Query Prioritization

The controller-side wireless module monitors the frequency of DALI commands issued by the DALI controller. For each command in the data cache, a priority is continuously computed that equates to the proportion of DALI stream bandwidth that is dedicated to issuing that command. This determines a target DALI stream utilization percentage for each command which is transmitted to all device-side wireless modules whenever the target utilization percentage changes by a predetermined threshold. In one preferred embodiment of the present invention, the predetermined threshold is 1 percent. Each device-side wireless module determines the available DALI bandwidth on its stream that is not being used for non-cached commands and proportionally divides it up based upon this target utilization percentage. An objective of the present invention is to keep high priority commands up to date. The present invention achieves this goal by interweaving commands. In the initial cycle, each command in the command list cache is issued consecutively. In subsequent data transmission cycles, the highest priority commands will be reissued frequently and lower priority commands will be omitted frequently. This will enable the back frame transmittal frequency distribution to essentially mirror the forward frame transmittal frequency distribution which in turn enables a minimization of data age within the DALI network.

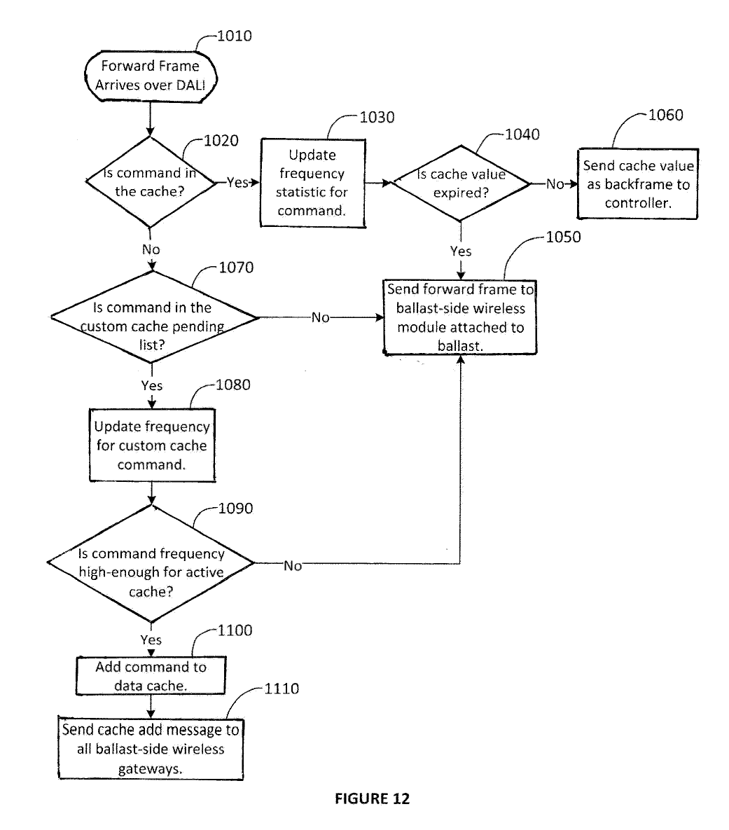

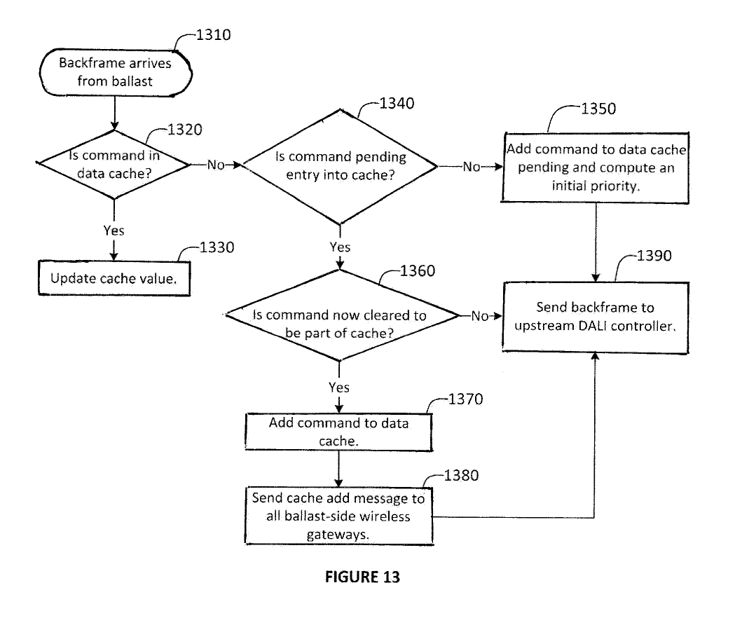

FIGS. 12 and 13 present flow charts of the method used to prioritize DALI command and back frames on a controller-side wireless module and device-side wireless module.

FIG. 12 depicts the control logic for prioritizing DALI commands (forward frames) from a DALI controller. In step 1010 a DALI controller transmits a DALI command to a controller-side wireless module. In step 1020 the controller-side wireless module determines whether the appropriate response data for that command is in the data store. If the appropriate data is in the data store then recalculate and update the command frequency statistic in step 1030. In step 1040, the timestamp of the data is checked to determine if the data is still valid. If the data is not deemed to be valid, then proceed on to step 1050. In step 1050, the controller-side wireless module sends the command to the device-side wireless module so that a new back frame can be transmitted from the controlled device back to the controller-side wireless module via the device-side wireless module. If in step 1040, the data is determined to still be valid then the data is transmitted as a back frame to the DALI controller.

Referring again to step 1020, if the command is not in the data store cache, the command is compared to a data store cache pending list. If the command is not in the data store cache pending list proceed to step 1050 and send the forward frame to the device-side wireless module. If the command is in the data store cache pending list, then proceed to step 1090 and determine if the command frequency is great enough to add it to the data store command list cache. If it is not issued frequently enough to be added to the data store then proceed to step 1050 and send the forward frame to the device-side wireless module. If the command is issued frequently enough to be added to the data store then proceed to step 1100 and add the command to the data store. In step 1110 send the new data store command list to all the device-side wireless modules.

FIG. 13 depicts the control logic for prioritizing DALI responses (back frames) from controlled devices using device-side wireless module command lists. Each device-side wireless module determines the amount of available DALI bandwidth which is not being used for unidirectional (non-cached) commands and proportionally divides it up based upon the computed or allocated utilization percentage. Each controlled device in a DALI network may have a different list of commands that it responds to than other controlled devices within the network and therefore each may have a different set of commands cached in its command list. This provides great flexibility for the system but also requires the controller-side wireless module to have enough random access memory (RAM) to manage the responses from each of the command lists.

In step 1310 the device-side wireless module receives a back frame from a controlled device. In step 1320, the device-side wireless module determines whether the command associated with that back frame is currently in the command list. If the command is in the command list, the device-side wireless module determines whether the command has been previously detected (i.e. has the command been issued by the DALI controller). If the command has not been previously detected no further action is required. If the command has been previously detected, then in step 1330 a timestamp for that command is updated in the command list cache; reflecting that the intended DALI controlled device is still actively responding to the command.

If in step 1320, it was determined that the command associated with the back frame is not in the command list cache, then the back frame is checked against a pending command list in step 1340. The pending command list contains a listing of commands that have been received but have a lower priority than commands in the command list. These low priority commands are not initially placed into the command list until their priority surpasses that of commands currently in the command list. If the command is not in the pending command list, the command is added to the pending command list in step 1350 and the back frame is transmitted back to the DALI controller in step 1390.

In step 1380, a time stamp is placed on the command, a counter recording how often the command is received is initialized, and an initial priority is assigned to the command. The time stamp allows the wireless gateway to track how frequently the DALI controller issues that command. If the command is in the pending command list, in step 1360 the counter is incremented and a determination is made as to whether that command should be moved from the pending command list to the command list cache. If the command list cache isn't full, the command may be added to the command list once it has been repeatedly issued over a several minute period. If the command list cache is full, then the pending command's priority is compared to that of the lowest priority command already in the command list cache. One method to determine the relative priority of the two commands may be to compare how frequently each command is issued. If the pending command is issued more frequently than the lowest priority command for a predetermined threshold time, then the lowest priority command is removed to the pending command list and the pending command is placed in the command list cache in step 1370. In step 1370 a notification message is transmitted to the controller-side wireless module to allow the controller-side wireless module to properly handle a forward frame requesting data from the associated queries.

In step 1380 the command list cache is transmitted to all device-side wireless modules. In step 1390 the back frame is transmitted back to the DALI controller.

Referring again to step 1360, if the pending command does not have high enough priority to replace any command currently in the command list cache the back frame is transmitted to the DALI controller without the associated command being added to the command list cache.

### Preemptive Cache Management

A method to reduce data latency in the data cache on the controller-side wireless module is implemented by adding application intelligence to a controller-side wireless module. This is accomplished in the present invention by designing a data structure that is specific to and for each DALI controlled device in the lighting system. The data structure maintains the appropriate value for each cached data command which cannot be derived from other values. As an example, the data cache stores a value indicative of the light level of an individual ballast but does not store a value indicative of whether the lamp for that ballast is lit. The latter parameter is a function of the former and can therefore be determined if the DALI controller queries whether the lamp is lit.

Latency in the system is also reduced by preemptively updating the cache when the controller-side wireless module receives a forward frame from the DALI controller which will make a chance to a particular controlled device. For example, if the DALI controller sends a command to change the light level, the cache will be updated with that light level and mark the value as “pending” until it can be confirmed that the ballast has moved to that light output. Once the actual light level has been confirmed, the “pending” flag is cleared. Alternatively, if a negative acknowledgement (NACK) is received or if a preconfigured amount of time elapses without receiving an update, the controller-side wireless module will revert the data value back and clear the “pending” flag as if the update never happens. This is based on the fact that mechanisms are in place to guarantee success of the outbound command and therefore have a nearly 100% likelihood that the pending value will take effect within a few milliseconds. This allows for the elimination of cache age for some parameters.

Due to the implications of this approach with lighting control systems, each of the facets of this approach can be individually enabled or disabled by the upstream DALI controller.

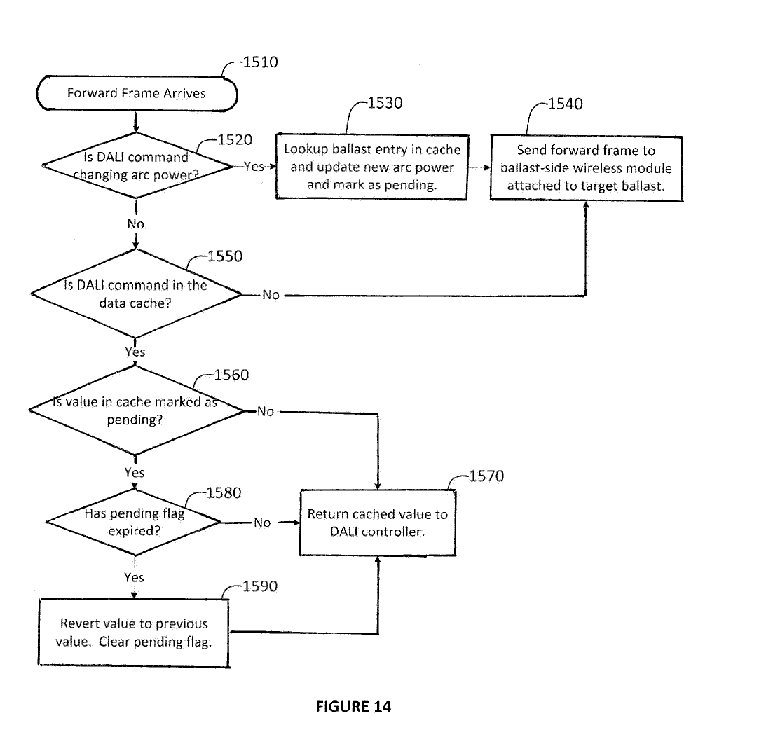

FIG. 14 depicts a flow chart for a method which allows for preemptive cache update control. In step 1510 a forward frame is transmitted from a DALI controller to a controller-side wireless module. In step 1520 the controller-side wireless module determines whether the forward frame is changing arc power in at least one ballast. If the command is changing arc power, proceed to step 1530 and lookup the ballast entry in the data store cache and update the new arc power and mark this entry as pending. In step 1540, send the forward frame to the device-side wireless module attached to the target ballast.

If in step 1520, the forward frame is not changing arc power, the controller-side wireless module determines if the command is in the data cache. If it isn't proceed to step 1540. If he command is in the data cache proceed to step 1560 and determine if the value in the data cache is marked as pending. If the command is not marked in the data cache as pending then proceed to step 1570 and return the cached value to the DALI controller. If the command is marked as pending then determine whether the pending flag has expired. If the pending flag has not expired then return the cached value to the DALI controller (step 1570). If the pending flag has expired, revert the value to the previous value and clear the flag (step 1590). Proceed to step 1570 and return the cached value to the DALI controller. For example, it is determined that the DALI controller is adjusting the light level (arc power) to 50% for a ballast and the same ballast was previously set to 100%. Once command is received the device-side wireless module would immediately issue the command to set the ballast arc power to 50% and follow by a query to confirm. The system would initially assume that it has successfully completed the arc power command and would reply to queries by the DALI controller that the light level is 50%. However if confirmation from the ballast is not received within some time period that confirms arc power of 50%, the system would then assume the operation failed and revert back to its last confirmed value, in this case 100%, when next queried by the DALI controller.

Ballast Groups with Exception List

Another method to improve memory utilization and reduce controller-side wireless module memory usage is to set up ballast groupings. A mechanism is provided when the characteristics and assumptions do not apply to allow performance with the only side effect of slightly increased worst-case memory utilization. In most lighting applications, there are scenarios where groups of ballasts existing in a zone or area are intended to behave identically to one another. Because of this, each ballast within the group typically has the same current light level and configuration as other ballasts in the group. This provides a memory optimization opportunity on the controller-side wireless module data cache by adopting an application specific cache table structure. While this approach typically saves memory, it also increases the CPU overhead required on the controller-side module.

Create dynamic in-memory groups of common ballast state and maintain a list of ballasts that adhere to the group. While the upstream DALI controller will typically have these ballasts assigned to a logical group in the control system, the groups here are dynamically created based on a realtime analysis of data from the ballasts. Ballasts are moved to the group that most closely matches the overall data state. Therefore, a group in the sense of data storage does not necessarily correlate to an actual lighting zone or area but typically will to some degree as it is this characteristic that provides the optimization opportunity.

Due to the dynamic nature of these groups and the number of configuration parameters, an exception list is used to handle ballasts that have some values that differ from the others in the group without necessitating the need to create a 1:1 relationship between groups and ballasts. The determination between adding group exceptions versus moving the ballast to another group or creating another group is based on a real-time computation of the memory implications of each decision.

Due to the nature of this technique, the worst-case scenario would involve each ballast being in a group by itself. This would occur if the system detects no optimization opportunities regarding memory given the data values for each cached parameter. This worst-case scenario does utilize more memory than the baseline case but is atypical in most deployments and on the whole this method saves memory.

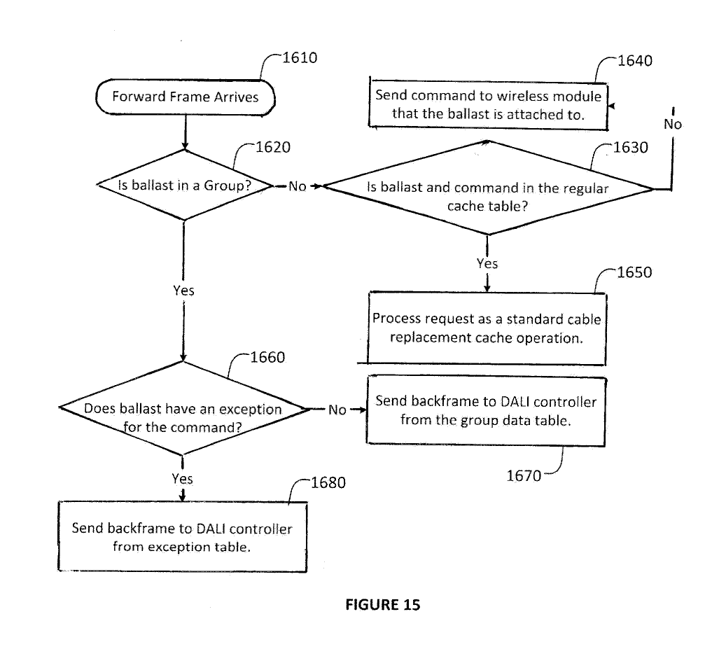

FIG. 15 provides a representative flow chart of a preferred embodiment of the method for grouping ballasts on command arrival to a controller-side wireless module. In step 1610 the forward frame arrives at the controller-side wireless module. In step 1620 the controller-side wireless module determines whether the command is targeted to a ballast in a current group. If the ballast and the command are in the regular cache table then the request is processed as a standard cable replacement cache operation (step 1650); if the ballast and command are not in the regular cache table then the command is sent directly to the device-side wireless module that the ballast is attached to (step 1640). Referring again to step 1620, if the ballast is already in a group then the controller-side wireless module determines if there is an exception for the command (step 1660). If there is an exception, then send the back frame associated with that command to the DALI controller from an exception table (step 1680). If there is no exception, then send the back frame to the DALI controller from the group data table.

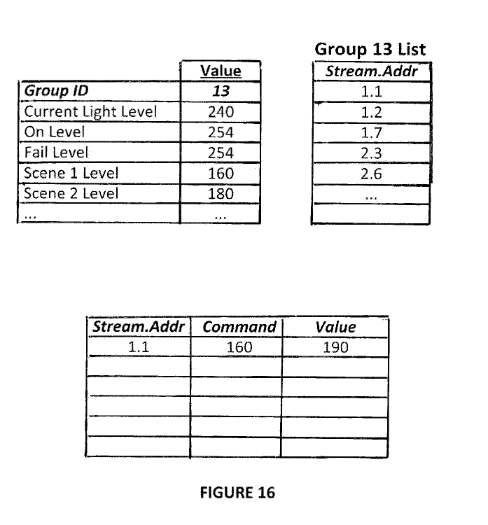

FIG. 16 provides a representative example of a ballast grouping memory table and a representative example of a ballast grouping exception table structure.

The present invention uses another method to reduce the amount of data transmitted wirelessly, which is to only transmit updates to the controller-side wireless module when the data in the cache has changed.

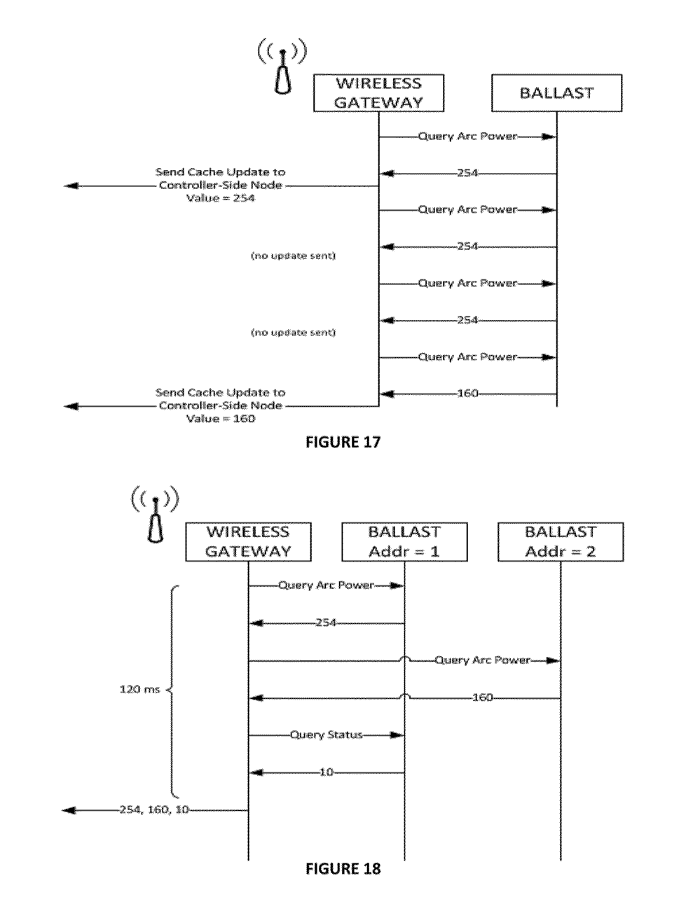

In cable replacement mode, each device-side wireless module attempts to fully utilize the available bandwidth on its DALI stream to issue commands that are part of the data cache. Rather than send a cache update message to the controller-side wireless module for each query transmitted to the device-side wireless modules, the device-side wireless modules can keep track of the last value for each command that is part of the cache and the last time that an update was sent to the controller-side node. The device-side wireless modules use this table and only send updates to the controller-side wireless module when the value has changed or when a preset time interval has elapsed between the instances when an update was sent. The device-side wireless module would re-transmit an unchanged value to protect against any errors with the data value being corrupted or otherwise stored incorrectly in the cache. FIG. 17 presents a representative example of the sequencing of cache updates upon a data value change. FIG. 18 presents a representative example of the sequencing of grouped cache updates.

This approach minimizes the intermediate network traffic while not adding any additional latency in getting the data to the controller-side wireless module.

Although several embodiments of the present invention, methods to use said, and its advantages have been described in detail, it should be understood that various changes, substitutions and alterations can be made herein without departing from the spirit and scope of the invention as defined by the appended claims. The various embodiments used to describe the principles of the present invention are by way of illustration only and should not be construed in any way to limit the scope of the invention. Those skilled in the art will understand that the principles of the present invention may be implemented in any suitably arranged lighting system. Those skilled in the art will also understand that the principles of the present invention may be implemented in any suitably arranged building control system. Examples of such building control systems include but aren't limited to energy minimization systems; heating, ventilation, and air conditioning (HVAC) systems, building security systems, and the like.

We claim:

1. A method for the transport of lighting control commands conforming to a protocol designed for hardwired network over a wireless gateway without special accommodation of the wired protocol or compatible devices to operate a wireless lighting control system comprising a controlling device; a wireless gateway; and at least one controlled device; the method comprising the steps of:
providing a command list populated with commands on a device-side wireless module;
providing a data cache populated with values on the device-side wireless module;
providing a data store on a controller-side wireless module;
said data store storing data;
said data comprising commands received from a lighting controller;
said data further comprising a response, such as back frames initiated at a controlled device and received from the device-side wireless module; and
transmitting the message to the lighting controller.

2. The method of claim 1 wherein the controlling device is a DALI controller.

3. The method of claim 1 further comprising the step of:
Monitoring the frequency with which commands are received from the lighting controller.

4. The method of claim 3 further comprising the steps of:
computing a utilization metric;
computing the available bandwidth on a device-side stream; and
dividing the bandwidth according to the utilization metric.

5. A method to improve memory utilization and reduce controller-side wireless module memory usage within a wireless lighting control system comprising a controlling device; a wireless gateway; and at least one controlled device; the method comprising the steps of:
providing a command list populated with commands on a device-side wireless module;
providing a data cache populated with values on the device-side wireless module;
providing a data store on a controller-side wireless module;
said data store storing data;
creating dynamic in-memory groups of common ballast state;
maintaining a list of ballasts that adhere to the group;
said data comprising commands received from a lighting controller;
said data comprising the list of ballasts that adhere to the group;
said data further comprising a response, such as back frames initiated at a controlled device and received from a the device-side wireless module; and
transmitting the message to the lighting controller.

6. The method of claim 5 wherein the controlling device is a DALI controller.

7. The method of claim 5 further comprising the step of:
Monitoring the frequency with which commands are received from the lighting controller.

8. The method of claim 5 further comprising the steps of:
computing a utilization metric;
computing the available bandwidth on a device-side stream; and
dividing the bandwidth according to the utilization metric.

9. A method to reduce data latency the data cache on a controller-side wireless module in a wireless gateway used to operate a wireless lighting control system comprising a controlling device and at least one controlled device; the method comprising the steps of:
adding application intelligence to the controller-side wireless module;
designing a data structure that is specific to and for each DALI controlled device in the lighting system;
wherein the data structure maintains the appropriate value for each cached data command which cannot be derived from other values.

10. The method of claim 9 wherein the controlling device is a DALI compatible controller.

11. The method of claim 9 further comprising the steps of:
reducing latency in the system by preemptively updating the cache when the controller-side wireless module receives a forward frame from the DALI controller which will make a chance to a particular controlled device.

12. The method of claim 9 further comprising the step of individually enabling the application intelligence for a particular controlled device.

13. The method of claim 9 further comprising the step of individually excluding the application intelligence for a particular controlled device.
